(19) United States
(12) Patent Application Publication
(10) Pub. No.: US 2019/0079480 A1
(43) Pub. Date: Mar. 14, 2019

(54) System and Method for Delivery of Variable Flow Haptics in an Immersive Environment with Latency Control

(71) Applicant: Whirlwind VR, Inc., Burlingame, CA (US)

(72) Inventor: Timothy Chia-Chieh Sun, Burlingame, CA (US)

(21) Appl. No.: 16/127,789

(22) Filed: Sep. 11, 2018

Related U.S. Application Data
(63) Continuation-in-part of application No. 14/870,335, filed on Sep. 30, 2015, now abandoned.
Application No. 14/870,335 is a continuation of application No. 14/660,326, filed on Mar. 17, 2015, now abandoned.

(51) Int. Cl. G05B 19/042; G08B 6/00

(52) U.S. Cl. CPC G05B 19/042; G05B 2219/2614; G08B 6/00

(57) ABSTRACT

The present embodiments disclose apparatus, systems and methods for allowing users to receive targeted delivery of haptic effects with latency control. The haptic tower may have an enclosed, modular assembly that manipulates air flow, fluid flow, scent, or any other haptic or sensation, for an immersed user, or may be a stationary installation for more industrial-scale or group use. Moreover, the system has an application of sensor technology to capture data regarding a users' body positioning and orientation in the real environment. This data, along with the data from a program coupled to the system, is relayed to the micro-controller with instructions coded thereon to direct air flow, variable intensity of air flow, variable temperature of air flow, and targeted dispensing of haptic effect with latency control. These features expand the sense of realism and immersion of a user in a virtual space. Other back-end functionalities may be taken advantage of by a user through an interactive mobile app or from the high-resolution, easy-to-use user-interface display. Aside from the sophisticated components and electronics delivering precision haptics, the intelligent and contextually-aware system also easily integrates with any home automated system via Wi-Fi, ZigBee, or Bluetooth 4.0. The system also easily connects to a cloud-based server allowing it to interface with the mobile app, enabling the user to choose from a variety of informative dashboard alerts and features. Moreover, a peer-sharing tool allows for users to share aspects of their immersive experience.

### CROSS-REFERENCE TO RELATED APPLICATION

This application claims the benefits of U.S. Non-Provisional patent application Ser. No. 14/870,335 filed on Sep. 30th, 2015, which further claims priority to U.S. Non-Provisional patent application Ser. No. 14/660,326 filed Mar. 17, 2015, and the subject matter thereof is incorporated herein by reference in its entirety.

### BACKGROUND

### Field

The field of the invention relates to sensory delivery systems and more particularly relates to a precise automated haptic system. Specifically, the invention relates to a haptic system with programmable logic for the latent-free delivery of variable flow haptics using a piston-displacement chamber assembly.

### Related Art

Virtual Reality (VR) aims to simulate a user's physical presence in a virtual environment. Over the past decade, with the rapid development of computer-generated graphics, graphics hardware, and modularization of processing elements and system components, VR has been ushered into the next revolution- Immersive Multimedia. Small-form factor devices, such as data gloves, haptic wearables, and head-mounted gear, have all enhanced the immersive experience in the virtual reality environment. Now, with the advent of sophisticated tracking technology, this immersive experience has even extended to the cinema experience; viewers will be able to change their perspective on a scene based on the position tracking of their eye, head, or body. This immersive and active viewing experience is poised to alter the way in which we will consume content in the future.

Along with a number of immersive developments in the virtual reality industry, there have been a number of developments in enhancing the sensory experience for a user. For example, force feedback in medical, gaming, and military technology is very well known in the art. 4-D movie theaters, replete with motion rocking, have long been providing viewers with a life-like experience. Developers have increased the sensory definition by stimulating a plurality of senses with an exceptionally high degree of realism.

Scientists from York and Warwick in England have developed a virtual reality cage called a Virtual Cocoon, in which a user is enveloped by a planetarium-style screen, not only surrounded by a stereoscopic visual and sound, but also by a sense of smell, touch, and even taste. This fully immersive, perceptual experience blurs the line between what is real and what is not. Holovis manufactures full motion domes- immersive and interactive platforms designed primarily for gaming, but can be scaled up for group interactive experiences. Stereoscopic projectors are edge blended and synchronized with ride motion technology, along with delivering a range of other sensory stimulants, such as smell and heat.

With respect to air blasting effects, Disney's Aireal and Microsoft's AirWave both employ a non-contact haptic feedback system using air vortex rings to deliver the air blasting effects. In the case of both systems, speaker drivers displace air in a chamber to eject the air vortex. The obvious limitations are that the speaker system—comprised of a cone in vibrational communication with a coil-coupled electromagnet—can only displace a limited volume of air. While the use of larger speakers can augment the volume of displaced air, the console would then undoubtedly loose its form factor for portable home use. Moreover, the speaker system of any size does not have any built-in sound mitigating measures, leading to significant disruptions in the users' haptic experience.

Likewise, there are a number of patent references providing for VR systems that deliver haptics. However, much like the Cocoon and Holovis, the background patent references provide a plurality of sensory mechanisms integrated with a user-surrounding platform or rig. The use of VR or entertainment platforms featuring a plurality of sensory mechanisms is well established in the background art, but not as individualized devices with home-use and universal integration capabilities. There are no claims or disclosure in the prior art addressing individualized units coupled to a code, instructing variable air intensity and temperature, stimulating a wide range of variable haptic situations in a virtual reality environment. Moreover, there are no claims or disclosure in the prior art revealing an actuated piston-chamber assembly as a means for causing air displacement in the context of an immersive environment.

As the foregoing illustrates, there is currently a gaping void for a home-use, stand-alone device, that may integrate into a variety of experience systems, and deliver target specific haptics with next generation realism, including air flow with variable intensity, temperature, and blast effects. Users no longer will have to rely on attending a VR convention or gaming room in order to experience this heightened immersion and sensory experience. No longer will they have to commit to large and cumbersome installations and platforms. Finally, with targeted haptics delivery, the sense of realism and immersion will be taken to the next level—all from the convenience of one's own home.

### SUMMARY

These and other features and improvements of the present application will become apparent to one of ordinary skill in the art upon review of the following detailed description when taken in conjunction with the several drawings and the appended claims.

This invention relates to the next generation of Immersion Multimedia, in which variable air flow and temperature haptics delivery is targeted to specific portions of the user corresponding to the user in the Virtual Space. Moreover, the apparatus, system, and method of which, does not rely on an installation or platform, but rather, is modularized for universalized integration.

The present invention fills a void left behind by the currently existing Immersion Multimedia products and references. The present invention provides for an apparatus, system, and method for the precise haptic targeting of specific portions of a user—mimicking conditions of the Virtual Space—in a modularized, universally integratable form.

In one generalized aspect of the invention, the air haptic device simulates variably intense wind, heating and cooling from the virtual space to enhance the user's sense of immersion. The hardware will include hot, cold and ambient settings with variable intensities for hot and cold based on power input and desired output temperature.

The apparatus may comprise a housing; at least one fan assembly; at least one duct; at least one temperature element; a processor; a memory element coupled to the processor; encoded instructions; wherein the apparatus is further configured to: receive data input from a user; receive data input from a program coupled to an experience; based on the received input data, control an air flow intensity; based on the received input data, direct air flow through at least one duct; based on the received input data, control a temperature element for heating or cooling the said air flow; and deliver a haptic output to a user.

In one preferred embodiment, the apparatus may be in the form of a haptic tower that individually has the capability to blow air at hot and cool temperatures with variable intensity. The fan assembly will have the capability to create a smooth, uniform flow of air, as opposed to an axial-style fan, which “chops” the air, resulting in a non-uniform flow of air. In one preferred embodiment, a variable control of air flow may be created by a variable controlled speed output from a motor actuated from a series of sensor-captured and code-instructed data inputs. In another embodiment, a variable controlled electro mechanical valve can vary intensity of air flow and pressure. Some embodiments may include the motor output to be coupled to a brake for tight control of the haptic air flow.

In one aspect of the invention, air temperature may be created by controlling the redirected air flow through heat sinks of hot and cool temperatures. Servo motors control dampers, flat plastic shutters, and these shutters will open and close controlling the air flow through different temperature ducts. After redirecting the air into one of the three separate ducts, each duct has either cold, hot or no temperature treatment to the out-flow of air. In this particular embodiment, the air flows through the “hot” duct with an exposed heating element. In some embodiments, for the hot duct, the air may flow through an exposed Positive Temperature Coefficient (PTC) ceramic heater element. In other embodiments, the heating element may be a condenser heat sink in a vapor-compression cycle, thermoelectric heating using Peltier plates, Ranque-Hilsch vortex tube, gas-fire burner, quartz heat lamps, or quartz tungsten heating, without departing from the scope of the invention. For the “cold” duct, the air flows through a cooling element. In some aspects of the invention, for the cold duct, the air may flow through a traditional finned air conditioning evaporator in a vapor-compression cycle. Alternate embodiments of the cooling element may include thermoelectric cooling using the Peltier effect, chilled water cooler, Ranque-Hilsch vortex tube, evaporative cooling, magnetic refrigeration, without departing from the scope of the invention. The last duct has ambient air bypassing both the heating and cooling elements. In another aspect of the invention, heating and cooling elements are integrated into a single duct providing for heated air, cooled air, and ambient air. In yet another aspect of the invention, more than three ducts may be provided in order to create heated air, cooled air, and ambient air.

It is a further object of the invention to provide an apparatus that may have an integrated air bursting element, delivering high velocity air flow directed at the user. In one embodiment, an array of miniature speakers may be used to create a large enough volume of air displacement within a chamber to generate a miniature air vortex. Another embodiment for the air bursting effect may entail air displacement with the use of a larger speaker or a sub woofer. These are able to displace more air in an electromechanical fashion. Other embodiments may include air vortices to create air bursting effects by attaching a rod supported by a rail system powered by a motor assembly. In yet another embodiment, an air compressor coupled to an electromechanical valve may be used to create the air bursting effect.

In a preferred embodiment, the air bursting effect may comprise a piston chamber assembly with a tapered nozzle to increase intensity and target specificity. In one embodiment, a spring-load system coupled to a drive-train and DC motor may deliver actuation of the piston enclosed in a chamber assembly. At the proximal end of the drive-train lies a sector gear, which picks up the rack on the piston; pulls the piston into a cocked position; a compression spring is compressed; and the sector gear releases the rack attached to the piston, releasing the piston with high velocity. Moreover, due to the proximity of the air bursting outlets to the existing impellor fan-mediated air ducts, variability with respect to intensity and temperature may be achieved in relation to the air bursting effect. In other embodiments, a valve may be activated redirecting the variable temperature and intensity air flow into the piston chamber assembly and, or air bursting effect outlet. The air bursting outlet may additionally be rotatable, and, or comprise a mechanical iris, allowing for the precise control of the size of the aperture—thereby controlling pressure and pinpoint dispersal of air burst. The rotation of the outlet and control of the iris associated with the air burst outlet may be manual, and, or dynamically via any number of sensors—including head and body tracking sensors.

In a preferred embodiment, target specificity for haptic delivery may be achieved using servo motors to pivot in place. In other embodiments, target specificity may be enhanced by using head tracking or full body tracking sensors. In yet another embodiment, this body tracking can also be used for the control and aiming of the dispensing nozzle at particular tracked body locations. An alternate embodiment may include nozzles that may shift the diameter of an outlet in order to alter the air flow pressure and haptic effect.

The system may comprise a processor; a memory element coupled to the processor; encoded instructions; at least one sensing means configured for detecting data related to a user's orientation and position, environmental conditions in user's real environment, and user's input signal; wherein the computer system is further configured to: receive data input from a user; receive data input from a program coupled to an experience; based on the received input data, control an air flow intensity; based on the received input data, direct the air flow through at least one duct; based on the received input data, control a temperature element for heating or cooling the air flow; and deliver a haptic output to a user.

In a preferred embodiment, a system configuration may comprise a modular surround haptic system with multiple towers. The multiple tower configuration may have a micro controller controlling all of the towers. In some embodiments, communication between the micro controller and the CPU will be USB. Other embodiments may allow communication between the micro controller and CPU by other known methods in the art. In some embodiments, the towers will be in direct communication with the CPU via any known communication protocol.

In one aspect of the invention, a system configuration may comprise a sensor to detect data related to a user's orientation and position, environmental conditions in users' real environment, and users input signal. In another aspect of the invention, a user may be surrounded by a plurality of sensors to detect data related to a users' orientation and position, environmental conditions in users' real environment, and users input signal. In other embodiments, the sensors may also include body-tracking, hand-tracking, head-tracking, or eye-tracking technology to be used for the control and aiming of the tower and nozzle at particular track body locations in order to achieve high resolution target specificity for haptic delivery. In further embodiments, sensor-captured data may communicate directly with the micro controller. In yet further embodiments, sensor-captured data may communicate directly with the towers, bypassing the micro controller.

It is yet a further object of the invention to provide a method that may comprise receiving data input from a user; receiving data input from a program coupled to an experience; controlling an air flow intensity; directing the air flow through at least one duct; controlling a temperature element for heating or cooling the air flow; and delivering a haptic output to the user with latency control. The processor or latency control module may sense a virtual event necessitating a sudden stop or slow down of the impellor fans and signal the motor output to apply an inverted voltage or reverse voltage in order to create a “sudden brake” effect. As a result, there is no lagging of the rotation of the impellor fans, and rather, there is a more responsive (less latent) haptic output corresponding to the virtual experience.

Aspects and advantages of this invention may be realized in other applications, aside from the intended application of gaming/interactive story telling/cinema/passive story telling. Other pertinent applications that may exploit the aspects and advantages of this invention are: tourism—simulation of the environment that is being digitally visited. For example, simulating the hot sun of the Gobi Desert or the warm sea breeze of Hawaii's beaches. Dating—simulating a method of signaling a potential dating match, such as by simulating a blown kiss. Architecture, design and real estate—the ability to simulate the use of an object that requires air flow to enhance the simulation. For example, designing or test driving a new motor cycle design and creating the unique experience of driving the motorcycle. Education—the haptic tower system will help reinforce learning of various subjects, making learning a visceral experience, as opposed to relying on the traditional methods of rote memorization. E-commerce—the ability to experience how a piece of clothing looks and feels in a certain temperature or air flow environment. For example, a specific piece of clothing that looks particularly good with a light breeze or movement by the user can be experienced in the particular setting. This would allow the user to experience the item in the particular setting without having to purchase the item and physically wear or use it in the setting.

Other aspects and advantages of the invention will be apparent from the following description and the appended claims.

### BRIEF DESCRIPTION OF DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention, and should not be taken as limiting its scope. With this caveat, embodiments of the invention will be described and explained with additional specificity and detail through the use of the accompanying drawings in which:

FIG. 1 is a front perspective view diagram of an apparatus in accordance with an aspect of the invention.

FIG. 2 is a block diagram of the air flow configuration in accordance with an aspect of the invention.

FIG. 3a is a block diagram of the cooling temperature feedback loop in accordance with an aspect of the invention.

FIG. 3b is a block diagram of the heating temperature feedback loop in accordance with an aspect of the invention.

FIG. 4 is a system diagram of the system configuration in accordance with an aspect of the invention.

FIG. 5 is a method flow diagram of the method of delivering haptics in accordance with an aspect of the invention.

FIG. 6 is a side exploded view of the piston chamber assembly of the air bursting system according to an aspect of the invention.

FIG. 7 is a block diagram illustrating the latency control feature in accordance with an aspect of the invention.

### DETAILED DESCRIPTION

In the following description, for purposes of explanation, numerous specific details are set forth in order to provide a thorough understanding of the invention. It will be apparent, however, to one skilled in the art that the invention can be practiced without these specific details.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

The present embodiments disclose apparatus, systems and methods for allowing users to receive targeted delivery of haptic effects—air flow of variable intensity and temperature—from a single tower or surround tower configuration. Each tower housing may have an integrated fan assembly creating air flow of variable intensity, along with an integrated temperature element within a duct, which treats the air flow with variable temperature. The haptic tower may have an enclosed, modular assembly that manipulates air flow, fluid flow, scent, or any other haptic or sensation, for an immersed user. The fan assembly may be any device for producing a current of air by movement of a broad surface or a number of such surfaces. The duct may be any channel, tube, pipe or conduit, by which air, fluid, scented air, or any other substances may be conducted or conveyed—and may or may not house the temperature element. The temperature element may be a heat exchanger that changes the temperature of air, fluid, scented air, or any other substance. Moreover, the system has an application of sensor technology to capture data regarding a users' body positioning and orientation in the real environment. This data, along with the data from a program coupled to the system, is relayed to the micro controller with instructions coded thereon to instruct the relevant towers to direct air flow, variable intensity of air flow, variable temperature of air flow, and targeted dispensing of haptic effect. These features expand the sense of realism and immersion of a user in a virtual space. Various other back-end functionalities may be taken advantage of by a user through an interactive mobile app or from the high-resolution, easy-to-use user-interface display. Aside from the sophisticated components and electronics delivering precision haptics, the intelligent and contextually-aware system also easily integrates with any home automated system via Wi-Fi, ZigBee, or Bluetooth 4.0. The system also easily connects to a cloud-based server allowing it to interface with the mobile app, enabling the user to choose from a variety of informative dashboard alerts and features. Moreover, a peer-sharing tool allows for users to share aspects of their immersive experience.

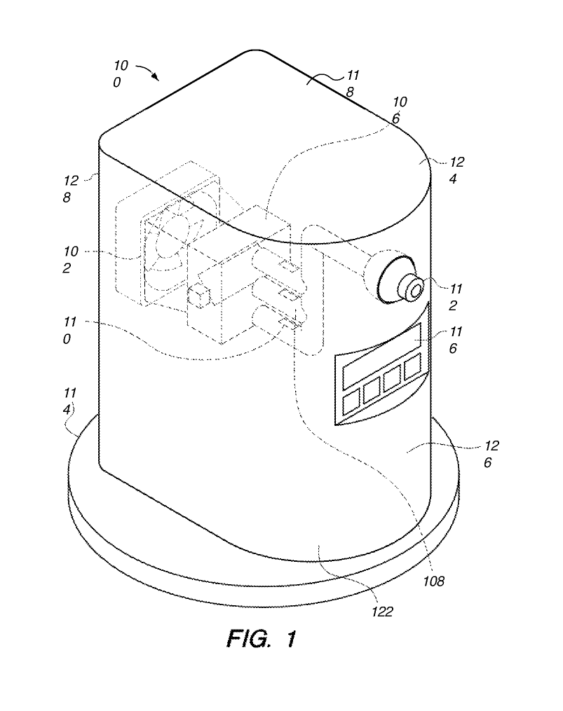

With reference now to the drawings, and in particular to FIGS. 1 through 5 thereof, a haptic delivery apparatus, system, and method embodying the principles and concepts of the present invention and generally designated by the reference numeral 100 will be described.

FIG. 1 is a front perspective view diagram illustrating an apparatus for the automated dispensing of targeted and precise haptics, in accordance with one embodiment of the present invention. A housing unit 100 dispenses air of precise air flow and temperature to targeted portions of a user based on data from a user in the virtual and real space. In the present example, the housing unit 100 may be a haptic tower 408 resting on the floor or a counter-top device, configured to house a fan assembly 102, but any number of fan assemblies 102 may be added, without departing from the scope of the invention. Likewise, while in the present example, the housing unit 100 may have a separate shutter 106, duct 108, and temperature element 110, depending on the desired temperature range, any number of shutters 106, ducts 108, and temperature elements 110 may be used, without departing from the scope of the invention. Other embodiments may be a stand-up haptic tower 408, although any size housing unit 100 is disclosed, including smaller, portable devices for on-the-go individual use, or larger units, with increased number of system components or more industrial strength components, appropriate for group applications.

The preferred embodiment of the housing unit 100 may have an integrated fan assembly 102, motor output 104, shutter 106, duct 108, temperature element 110, dispensing nozzle 112, rotatable base 114, and interface display 116. Housing unit 100 may encompass a housing top wall 118, bottom wall 120, and side walls 122, 124 that wrap around to meet the front wall 126 and back wall 128. Front wall 126 may have a dispensing nozzle 112 for targeted delivery of precise haptics onto a user. Front wall 126 may also have a user interface display 116 for mediating user interaction with dispensing device.

In other embodiments, though not shown in FIG. 1, the housing unit 100 may have flat side walls 122, 124 and flat front and back walls 126, 128. The front wall 126 may have a dispensing nozzle 112 hidden behind a flush wall with the means of opening and closing. The dispensing nozzle 112 may have separate outlets for air, fog, and mist. Additionally, the dispensing nozzle 112 may have the ability to rotate, or change the diameter of the inlet, in order to target the direction of the air flow, as well as alter the intensity of the air flow. Although not shown in FIG. 1, the housing unit 100 may have a front wall 126 void of dispensing nozzles, rather, the haptic delivery may be via a vent system, or any other outlet. The front wall 126 may be void of the user interface display 116, and rather, may be included in the mobile device application.

In further detail, still referring to FIG. 1, a housing unit 100 may have a rotatable base 114, which may pivot the housing unit 100 in at least one axis of motion. A rotating base 114 allows for the housing unit 100 to rotate on its base to allow for more targeted delivery of haptic effects. More particularly, a rotating base 114 may allow for the housing unit 100 to rotate on its base in at least one axis of motion to provide for a panning air flow effect. In other embodiments, the rotatable base 114 may allow for motion along multiple axis of rotation. In one embodiment, pivoting and targeted haptic delivery may be further enhanced by using head tracking or full body tracking system. Other embodiments may include a housing unit 100 with a dispensing nozzle 112, the pivoting and rotation of which may be also enhanced with the addition of head tracking or full body tracking systems.

With continuing reference to FIG. 1, a housing unit 100 may include a user interface display 116, wherein the user interface may be integrated as a built-in console display. While in the present example, a built-in console display is shown, any type of user interface display 116 may be disclosed, including a mobile device display, a wearable device display, monitors, or any type of access device, without departing from the scope of the invention

In a preferred embodiment, the user interface display 116 may include a display page for receiving a request for a haptic output selection. The request being from a menu, a haptic suggestion engine, or user-initiated. The display page may then prompt a user to confirm the request. Other embodiments may include a display page that does not require a user to confirm the request, and instead, signals confirmation of the request and initialization.

Alternate embodiments may involve a user interface display 116 authenticating a user by any form of short-range or long-range wireless protocol standards, without departing from the scope of the invention. In authenticating a user, an authentication module may be further caused to recognize the user device at a particular haptic tower housing a unique short-range communication tag. The module may identify and authenticate the particular tower and user device by recognizing the unique tag, and then, authenticate the user by identifying the user device located at the particular tower. The unique, short-range tag may be a NFC tag, RFID chip, Bluetooth, ZigBee, or any short-range or long-range communication protocol standard. Additional methods of authentication may be accomplished via user input.

In yet another embodiment, the user interface display 116 may include a voice-activated request option receiving a request voice command, whereby the request voice command may be in communication with a voice-activated module querying at least one pre-defined database based on the request voice command. The voice-activated module may be in communication with a natural language module, whereby the request voice command is sent from the voice-activated module to the natural language module. The natural language module may be configured to convert the request voice command into a haptic output instruction querying at least one pre-defined database based on the request voice command.

In yet another embodiment, the user interface display 116 may receive a request voice command for a haptic output selection and interact with a user via voice response by having a voice activated module in communication with the natural language module and the voice activated module in communication with a voice response module, whereby the voice response module alerts the user of the various stages of the haptic output selection via the voice-activated user interface using natural language to describe the various stages of processing, from an introduction and identification of a user; to a haptic output selection inquiry or request or suggestion; to confirmation of a haptic output selection; and finally, initialization.

Still referring to the user interface display 116, the user may calibrate the maximum and minimum temperatures based on the users' preference. For example, if the user is hot, the user may calibrate the system to emit only cool air and not activate the hot side at all, and vice versa, for a cold user. If the user does not want to have air haptic sensation as a part of the virtual experience, the user may override the software experience and use the system as a normal heating, cooling or fan system. A manual system override feature may be present on the interface display 116 for the haptic system control.

Although not shown in FIG. 1, some embodiments may include a housing unit 100 that includes an air bursting effect system. The air bursting effect system delivers high velocity air flow directed at the user. According to one embodiment, the air bursting effect is created by the use of air vortices. Rather than using a manually actuated bag attached to bungee cord, a handle may be attached to an actuating rod supported by a rail system powered by a motor assembly. The rail system may have a spur gear with only half the teeth around the perimeter so that when the rack on the slider is no longer in contact with the gear teeth, the slider is pulled forward by the spring.

In other embodiments, an array of miniature speakers to create a large enough volume of air displacement within a chamber to generate a miniature air vortex may be used. Another air bursting effect system may create air displacement via the use of a larger speaker or a sub woofer. Some embodiments may include creating air bursting effects through the use of compressed air. Using an air compressor with an air tank, fitted with an electro mechanical valve, aimed at the user, a burst of compressed air can be used to enhance the users sense of presence. A variable controlled electro mechanical valve can vary intensity of air flow and pressure. While in the present examples, the air bursting effect system may be integrated within the housing unit 100, air bursting effect systems not integrated within the housing unit 100, but rather, as a separate unit is disclosed, without departing from the scope of the invention.

In yet other embodiments, a piston-chamber assembly may be employed, whereby a piston-like member with a terminal, wide-diameter head is coupled to any one of a number of actuators. Upon activation of the actuator, high-velocity movement of the piston head slidably disposed within a barrel may cause an appreciable displacement of air necessary for an air blast effect. Some embodiments may include air blast outlets that are adjacent to the impellor-fan assembly dispensing nozzle for convergence of air blast with temperature treated air, while others may feature a shutter and valve system redirecting temperature treated air into the piston chamber assembly and, or dispensing nozzle, and, or air blast outlet. In one embodiment, a rotatable outlet may be controlled manually or dynamically via any one of a number of sensors, or more particularly, by head and body tracking sensors. In some other embodiments, a mechanical iris shutter may be fitted onto the outlet to control the size of the opening for a more pressurized and, or pinpoint dispensing of air blast.

Although not shown in FIG. 1, in yet another aspect of the invention, a housing unit 100 may include a fog and mist dispensing system. In an exemplary embodiment, a sprinkler or misting system may be connected to a water pump attached to an electric controlled check valve to allow the precise release of water in a mist-like fashion. In another embodiment, the fog and dispensing system may include at least one fluid supply line in fluid communication with at least one fluid supply and with at least one outlet; condensing means for air and fluid from the fluid supply; and dispensing fog or mist via an outlet. In some embodiments, the outlet may be a dispensing nozzle 112 or vent. In some other aspects, the fluid supply line may be in direct communication with the dispensing nozzle 112 emitting air flow as well, or the fluid supply line may be in direct communication with a dispensing nozzle 112 exclusive to the fog or mist. In other embodiments, water misting device or water jet attachment subsystems can be attached to the haptic tower, much like the modularized air bursting effect systems attached to the haptic tower. Using misting systems connected to a water pump attached to an electric controlled check valve, the system may allow for the precise release of water in a mist like fashion. Likewise, in some embodiments, a scent system including a scented-air supply connected to a pump, attached to an electric controlled check valve, may allow for the precise delivery of scented-air.

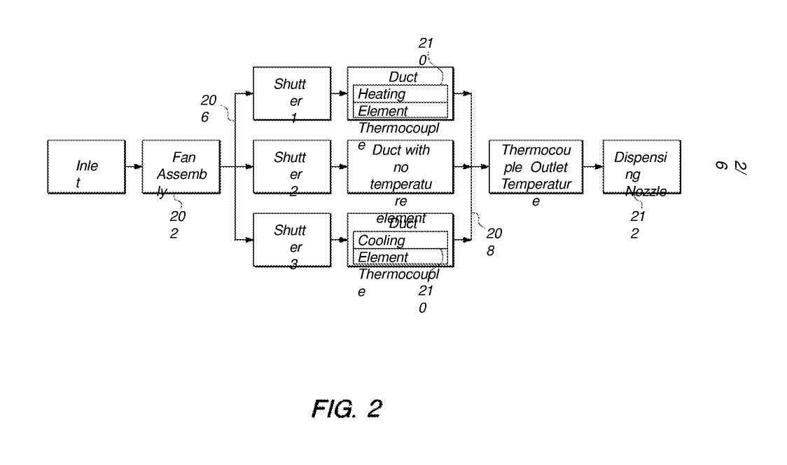

FIG. 2 shows a block diagram of the air flow configuration in accordance with one embodiment of the invention. The fan assembly 202, controlled by a motor output 204, creates air flow of variable intensity, and the air flow is directed through either hot, cold, or ambient shutters 206, whereby the air is directed through a respective temperature duct 208. Air flow is treated with variable temperature by a temperature element 210. Air flow of variable intensity and temperature are then directed out of an outlet 212.

In one exemplary embodiment, the fan assembly 202 may be a blower fan (also known as a squirrel cage) to produce a smooth, uniform flow of air. Traditional axial desk fans “chop” the air up and produce a non-uniform flow of air, which is not ideal for this application. The motor output 204 powering the blower fan assembly 202 will have a variable controlled speed output. In other exemplary embodiments, the fan assembly 202 will be an impeller design, or any design that may create a smooth, uniform flow of air. Other embodiments may include a brake for tight control of the output air flow from the fan assembly 202. Airflow will have a range of approximately 0 to 200 CFM.

In yet another exemplary embodiment, the air flow is directed to specific shutters 206, whereby it is channeled into respective ducts 208, and appropriately treated with temperature by a temperature element 210. Servo motors may control dampers or flat shutters 206, and these shutters 206 will open and close, controlling the air flow through different temperature ducts 208. After redirecting the air into one of the three separate ducts 208, each duct 208 has either a hot, cold or no temperature element 210. After redirecting the air into one of the three separate ducts 208, each duct 208 has either cold, hot or no temperature treatment to the out-flow of air. For heated air, the air flows through the “hot” duct 208 with an exposed heating element 210. In a preferred embodiment, the air may flow through an exposed Positive Temperature Coefficient (PTC) ceramic heater element, or any thermistor with a high non-linear thermal response, such as barium titanate or lead titanate composites. In other embodiments, the heating element 210 may be a condenser heat sink in a vapor-compression cycle, thermoelectric heating using Peltier plates, Ranque-Hilsch vortex tube, gas-fire burner, quartz heat lamps, or quartz tungsten heating, without departing from the scope of the invention. For the “cold” duct 208, the air flows through a cooling element 210. In a preferred embodiment, the air may flow through a traditional finned air conditioning evaporator in a vapor-compression cycle. Alternate embodiments of the cooling element 210 may include thermoelectric cooling using the Peltier effect, chilled water cooler, Ranque-Hilsch vortex tube, evaporative cooling, magnetic refrigeration, without departing from the scope of the invention. For the ambient duct 208, air bypasses both the heating and cooling temperature elements 210. In alternate embodiments, the air from the fan assembly 202 is directed into a single temperature duct 208, where the air is exposed to both heating and cooling temperature elements 210 integrated into the single temperature duct 208. Other embodiments may include heating or cooling the air flow into any number of shutters 206, temperature ducts 208, and temperature elements 210, without departing from the scope of the invention.

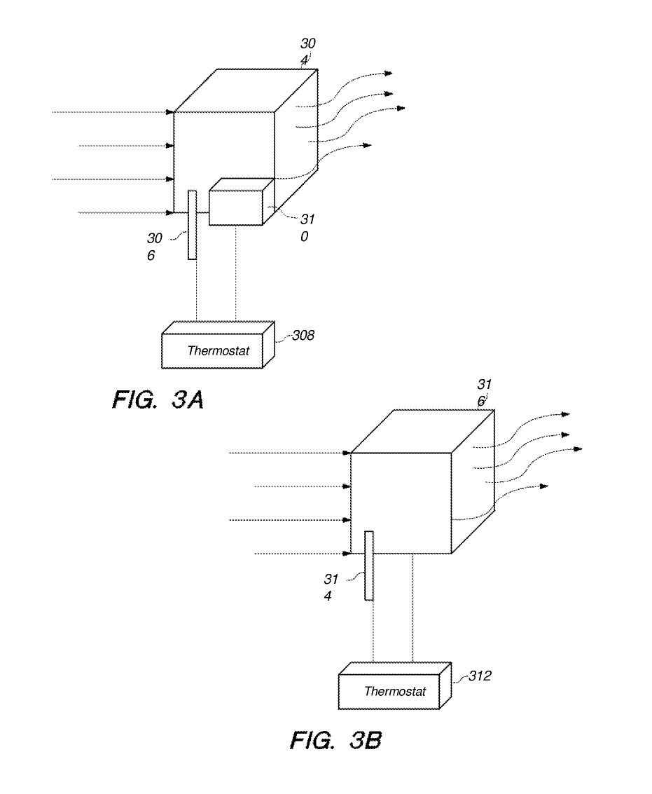

FIG. 3a shows a block diagram of the temperature feedback loop for a cooling element. In one preferred embodiment, the finned condenser or any cooling element 304 requires a temperature sensor 302, such as a thermocouple, in contact with each cooling element 304 to monitor the temperature of the temperature ducts 306. These temperature sensors 302 may be an infrared sensor, bimetallic thermocouple sensor, pressure spring thermometers, or infrared camera. Any one of these temperature sensors 302 may keep the temperature of the temperature ducts 304 at a constant temperature, through a feedback loop with the micro control board. In this exemplary embodiment, a thermostat 308 is set to a specific temperature range that it desires to reach using software signals from the CPU 406. The thermostat 308 then measures the temperature using the temperature sensor 302. Based on what the measured temperature is compared to the set temperature range, the thermostat 308 acts as a relay device that sends an on/off signal to the cooling compressor 310 to turn on/off. As more air flows through the cooling element 304, more air is cooled and the cooling element 304 will heat up in temperature, triggering the thermostat 308 to turn on the cooling compressor 310.

FIG. 3b illustrates a block diagram for the temperature feedback loop for a heating element. In accordance with an exemplary embodiment, the thermostat 312 is set to a specific temperature range that it desires to reach using software signals from a CPU 406. The thermostat 312 then measures the temperature using the temperature sensor 314. Temperature sensors 314 may include infrared sensors, bimetallic thermocouple sensors, pressure spring thermometers, or infrared cameras. Based on what the measured temperature is compared to the set temperature range, the thermostat 312 acts as a relay device that sends an on/off signal to a switch that allows current to flow through the heater element 316 which heats the heater element 316. As more air flows through the heater element 316, more air is heated and the heating element 316 will cool down in temperature, triggering the thermostat to power the heater element.

Pre-heated and pre-cooled temperature ducts 304, in combination with shutters 206, will help maintain the low latency of the virtual environment demands. Low latency of the environmental simulation is important to the experience of the user because when the user sees visual cues, the environmental simulator needs to respond immediately, otherwise a lag between the sense of feeling and environment can have an undesirable effect. Latency is the interval between the stimulation and response, or also known as the time delay between the cause and effect of some physical change in the system being observed. For example, the user raises his arm in the physical world and his arm in the virtual world raises with an obvious delay representing high latency of the system.

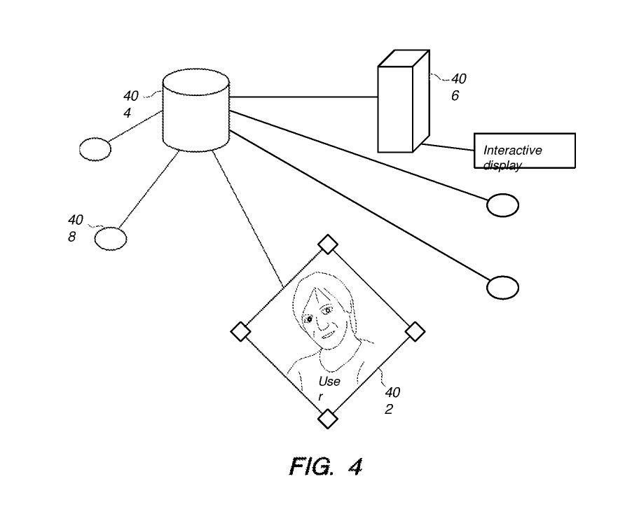

FIG. 4 shows a system diagram of the surround haptic system configuration. In one general aspect of the invention, a system may comprise of a sensor or a series of sensors 402 to detect a users' body position and orientation. Although not shown in FIG. 4, in other embodiments, a higher resolution of data capture related to user position and orientation may be achieved using body-tracking, hand-tracking, head-tracking, or eye-tracking sensors. Tracking enables the measuring of simple behaviors of a user in the physical world. For example, the user took one step forward in the physical world and the distance of one step was measured and tracked by a computer system with precise coordinates. When tracking data is available in the system computer, it can be used to generate the appropriate computer-generated imagery (CGI) for the angle-of-look at the particular time. For example, when a users' head is tracked, the computer system renders the corresponding computer-generated imagery to represent the digital world. Examples of tracking may be the use of a depth sensing camera for hand tracking; electromagnetic motion tracking for limb and body tracking; LED array tracking; accelerometer tracking; eye tracking; and eye-tracking with infrared and near-infrared non-collimated light to create corneal reflections. Audio sensor data may also be a part of the user input data.

Another feature to enhance presence is to control the direction of the haptic tower 408 using motors which allow haptic towers 408 to pivot in place by its rotatable base 114 and mimic the virtual environment the user is in. This can be further enhanced by using head track or full body tracking. This body tracking may also be used for the control and aiming of the rotatable dispensing nozzle 112 at particular track body locations. Additionally, in an alternative embodiment, spacialization software within the virtual experience with adaptive algorithms may change the intensity of air flow based on tracking of the users' position in the virtual space. These features effectuate targeted delivery of haptic effects, enhancing the immersive VR experience for the user.

In other embodiments, user environment sensors, either attached to the user or placed near the user, give the system an initial temperature reading to customize the experience to the users' environment state. For example, if the ambient temperature near the haptic towers 408 is cold, the system can compensate by setting the temperature experience to omit cold temperature output. In yet another embodiment, flow sensors at the users' location or at the outlet of the haptic towers 408 measure and control the flow output of the fan assembly 202, mist output and burst output. Alternative embodiments may include measuring the flow output of the fan assembly 202 by measuring the rotating speed of a motor in a fan assembly 202. Other embodiments include audio sensor data as being a part of the user input data.

Still referring to FIG. 4, the user data captured by the sensor or sensors 402 related to user body position and orientation, may be communicated to the micro controller 404, which will relay input signals from sensors 402 and relay output commands to the haptic towers 408, via a CPU 406. The micro controller 404 may be a small computer or a single integrated circuit containing a processor core, memory and programmable input. The micro controller 404 codes the data from the CPU 406, including user data from the sensors and program content data, to actuate the haptic towers 408 to deliver the haptic effects. In one embodiment, system configuration may include haptic towers 408 that wirelessly communicate with the CPU 406 through any short-range mode of wireless communication, such as Wi-Fi, UWB, Bluetooth, ZigBee, or any protocol standards for short range wireless communications with low power consumption. Each haptic tower 408 may send and receive commands to the CPU controlling the experience. Another embodiment of the system may have the haptic towers 408 connect to the CPU 406, directly without a micro controller 404, through USB, or any cable, connector and communication protocols used in a bus for connections, communications, and power supply for electronic devices. The CPU 406 would communicate directly with each haptic tower 408 sending and receiving data in coordination with the sensor user data and coded experience data. This configuration would have each haptic tower 408 powered independently or through a power controller where each additional haptic tower 408 would connect to the power controller.

In another configuration, the flow of data communication may be the through a wired connection where each haptic tower 408 would be wired to a micro controller 404, and the micro controller 404 is wired to the CPU 406, through USB, or any cable, connector and communication protocols used in a bus for connections, communications, and power supply for electronic devices. The haptic towers 408 would send sensor data to the micro controller 404, which would relay the data to the CPU 406. The CPU 406 would interpret the data and respond accordingly by sending commands to the micro controller 404, which would relay the commands to the associated haptic tower 408. In yet another embodiment, the haptic towers 408 may wirelessly communicate with the micro controller 404, bypassing the CPU 406, by any of the known method of short-range wireless connection, such as Wi-Fi, UWB, Bluetooth, ZigBee, or any protocol standards for short range wireless communications with low power consumption. Each haptic tower 408 can be powered through the micro controller 404, or independently powered. The micro controller 404 may be placed on a computer desk near the CPU 406. A USB connection may connect the micro controller 404 to the CPU 406. Additionally, a power cord may be plugged into a standard AC120V socket, which is attached to the micro controller 404. In one embodiment, the haptic tower 408 may have a power cord or control wire that will plug into the micro controller 404. While in the present example, the haptic tower 408 and micro controller 404 are networked via a cord or wire, other embodiments may include communicating over wireless short-range or long-range networks.

In one preferred embodiment, not shown in FIG. 4, a high-level initialization protocol may begin with establishing a micro controller and CPU connection and confirming power of the micro controller. In another embodiment, the system may establish connection with each haptic towers individually in a configuration void of a micro controller hub. Next, the initialization protocol may confirm if each haptic tower is upright and in the right orientation; read initial temperature readings from all thermometers; confirm user positioning—location relative to haptic towers; read initial positions of all servo motors, damper shutter motors, tower positioning motors, nozzle motors; confirm motors are operational; next, set all servo motors to default positions; confirm motor positions with output position; confirm minimum distance between user/object and the haptic tower outlet; confirm the functionality of the heating and cooling temperature elements; confirm with thermometer reading max/min temperature with the max power to heating/cooling element relative to room temperature; then, safely confirm no overloading of circuitry or overheating; and confirm fan motor functionality and confirm command speed with tachometer input speed.

In another preferred aspect, also not shown in FIG. 4, a high-level communication protocol may include a CPU communicating with a haptic tower library to create a programmed experience of specific output haptics. The CPU may then send instructions to a haptic tower micro controller (MCU) via USB, USCI, I2C, SPI, UART, or other wireless communications protocols, which may, in turn, coordinate actuation of motors in series, or in parallel, to deliver the latent-free haptic experience. The use of a micro controller hub, as opposed to a haptic tower micro controller, may also be used to coordinate function of motors, without departing from the scope of the invention. The haptic micro controllers may drive actuation of motors using pulse-width modulation (PWM). Pulse-width modulation signals result in latent-free responses and allow for variable control of a driver and actuator.

More particularly, still referring to a preferred embodiment of the communication protocol, simultaneous control of the haptic experience will be integrated into the onboard micro controller (MCU). For example, the CPU sends the coordinates of the haptic experience to the MCU through a dedicated communication line. The combination of predictive algorithms integrated into the MCU and the communication protocol from the CPU, allows the MCU to predictively lower haptic experience latency to generate a unique and specific entertainment experience. The MCU is configured to interpret the positional data and simultaneously coordinate the actuator array to precisely deliver the haptic output. Typical CPU loads are high due to the graphical intensity and computing power required to create low latency virtual reality experience. As a result, allowing the MCU to interpret and drive the haptic experience in an autonomous manner offloads the CPU requirements and decrease latency between the visual image and haptic experiences. Alternatively, series control of the haptic experience may be integrated into the on-board MCU to off-load CPU demands and decrease latency as well. An additional dedicated communication line between the CPU and on-board MCU may embody the user profile and contextual information. This user profile and contextual information may be a combination of data points ranging from local weather, wearable temperature data, user preferences, user health data, etc. This data may then be used to augment the sensor data and content data to drive an even more personalized haptic experience—in a low-demand and low-latency environment.

While not shown in FIG. 4, in yet another configuration of the communication protocol, the on-board MCU may be an autonomous power management tool that can ultimately determine the power requirements for each element. For example, if specific haptic towers will not require the cooling requirement, the MCU can autonomously control the power supply to the cooling temperature element. This improves the overall power efficiency of the system without losing the required low latency experience. Another embodiment of a communication protocol may be for a comprehensive safety monitoring system. Each haptic tower is fitted with moving motors, heating and cooling temperature elements that can create a number of hazards. The continuous communication between the CPU and MCU is required due to a need to protect the user from any hazard. Continuous monitoring of circuit behavior, thermometers, motor output, and complex simultaneous and series systems are important for user safety and hazard mitigation. This dedicated line will communicate with a dedicated line to ensure the CPU knows when to halt any virtual experience and draw attention to the user in case of an emergency in the form of a dashboard alert formatted for an interface display.

According to one embodiment, the system will be a modular surround haptic system, as shown in FIG. 4. The system may include either the two or four haptic tower 408 configurations with a micro controller 404 controlling all of the haptic towers 408. The user may then set up each haptic tower 408 approximately three feet distance from the users' torso depending on how many haptic towers 408 are set up. The user may orient each haptic tower 408 such that the air outlet or dispensing nozzle 112 may be pointed towards the users' torso/head area. In some embodiments, height may be adjustable via either sliding the system up or down on a tripod system. The user may be able to manually adjust the dispensing nozzle 112 direction in the desired angle for the user. Automated head/body tracking may allow the system to automatically aim at the user. Some embodiments may include haptic towers that move dynamically within a confined space to simulate wind or other air displacement from multiple points of origin, greatly expanding the degree of locational specificity, as compared to static towers. Alternate embodiments may include system configurations with any number of haptic towers, featuring at least a single haptic tower.

In some aspects of the invention, the location of the individual haptic towers 408 within the surround system configuration may be calibrated. Software and hardware may recognize the location of each haptic tower 408 to accurately simulate the virtual environment. The location may be fixed for each haptic tower 408, where each haptic tower 408 will be manually labeled with a location of where that haptic tower 408 is intended to be oriented relative to the user. In another aspect, calibration of the location of each haptic tower 408 may not need a fixed set location, rather the user may set each haptic tower 408 to a location using software confirming each haptic towers location. In yet another aspect, calibration of tower location may be automated, obviating the need for user input.

In continuing reference to FIG. 4, a system may include an interactive display, wherein the interactive display may be any one of the following: a head-mounted display; a display screen; a 3-D projection; and a holographic display.

While not shown in FIG. 4, embodiments may include the addition of a remote server to provide for back-end functionality and support. The server may be situated adjacent or remotely from the system and connected to each system via a communication network. In one embodiment, the server may be used to support verification or authentication of a user and a mobile device application function. In authenticating a user, a server may be further caused to recognize the user device at a particular system component, whether it is a haptic tower, micro controller, or any other system component that may be able to house a unique short-range communication tag. The server may identify and authenticate the particular component and user device by recognizing the unique tag, and then, authenticate the user by identifying the user device located at the particular component. The unique, short-range tag may be a NFC tag, RFID chip, Bluetooth, ZigBee, or any short-range communication protocol standard. The remote server may be further configured to support a user haptic output history function; help support a network sharing function; and support a haptic output selection search engine. The remote server may be further configured to provide a user-control system, which authenticates the user and retrieves usage data of the user and applies the data against a predefined criteria of use.

Other embodiments may include a remote server that is configured to provide a contextually-aware haptic output suggestion engine, which may access the user haptic output history function and at least one user contextual information to cause the processor to display a suggested haptic output on at least one display interface 116. Provisioning of the remote server may be delivered as a cloud service. In yet other embodiments, a haptic tower 408 may be associated with an Internet of Things, whereby the haptic tower 408 is fully integrated into a users' home automation system, thereby providing additional contextual information for a contextually-aware haptic output suggestion engine.

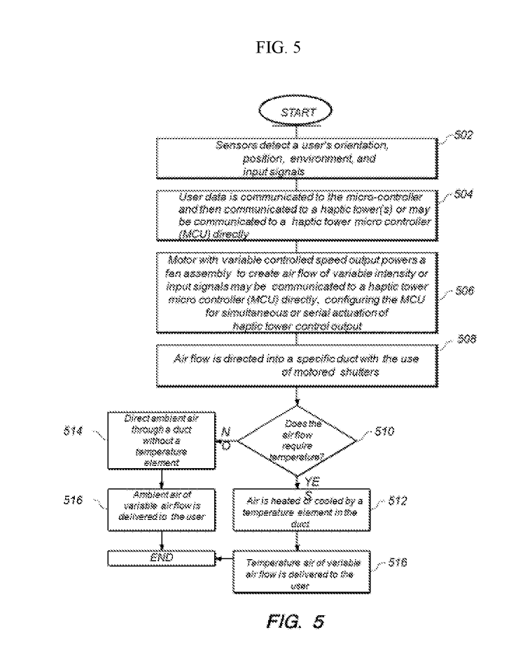

FIG. 5 shows a method flow diagram for the method of delivering precise and targeted haptic effects of variable air flow and temperature to a user. The preferred components, or steps, of the inventive method are as follows: first, in step 1 502, sensor or sensors 402 may detect user position and orientation. The user data captured by the sensor or sensors 402 related to a user body position and orientation, may be communicated to the micro controller 404, which relays the signal to the CPU 406. Alternatively, a higher resolution of data capture related to user position and orientation may be achieved using body-tracking, hand-tracking, head-tracking, or eye-tracking sensors. Tracking enables the measuring of simple behaviors of a user in the physical world, in order to virtualize the user and further actuate rotation of the base, as well as nozzles 112, for precise and targeted delivery of haptics onto a user. Examples of tracking may be the use of a depth sensing camera for hand tracking; electromagnetic motion tracking for limb and body tracking; LED array tracking; accelerometer tracking; eye tracking; and eye-tracking with infrared and near-infrared non-collimated light to create corneal reflections. Audio sensor data may also be a part of the user input data.

step 2 504, user data may be communicated to the micro controller 404 and then communicated to the haptic towers 408. The micro controller 404 may code the data from the CPU 406, including user data from the sensors 402 and program content data, to actuate the haptic towers 408 to deliver the haptic effects. The user data captured by the sensor or sensors 402 related to user body position and orientation, may be communicated to the micro controller 404, which relays the signal to the CPU 406. The micro controller 404 codes the data from the CPU 406, including user data from the sensors 402 and program content data, to actuate the haptic towers 408 to deliver the haptic effects. One embodiment may include haptic towers 408 that wirelessly communicate with the CPU 406 through any short-range mode of wireless communication, such as Wi-Fi, UWB, Bluetooth, ZigBee, or any protocol standards for short range wireless communications with low power consumption. Each haptic tower 408 may send and receive commands to the CPU 406 controlling the experience.

Another embodiment may have the haptic towers 408 connect to the CPU 406, directly without a micro controller 404, through USB, or any cable, connector and communication protocols used in a bus for connections, communications, and power supply for electronic devices. The CPU 406 would communicate directly with each haptic tower 408 sending and receiving data in coordination with the sensor user data and coded experience data. This configuration would have each haptic tower 408 powered independently or through a power controller where each additional haptic tower 408 would connect to the power controller.

In another configuration, the flow of data communication may be the through a wired connection where each haptic tower 408 would be wired to a micro controller 404, and the micro controller 404 is wired to the CPU 406, through USB, or any cable, connector and communication protocols used in a bus for connections, communications, and power supply for electronic devices. The haptic towers 408 would send sensor data to the micro controller 404 which would relay the data to the CPU 406. The CPU 406 would interpret the data and respond accordingly by sending commands to the micro controller 404, which would relay the commands to the associated haptic tower 408.

In yet another embodiment, the haptic towers 408 may wirelessly communicate with the micro controller 404, bypassing the CPU 406, by any of the known method of short-range wireless connection, such as Wi-Fi, UWB, Bluetooth, ZigBee, or any protocol standards for short range wireless communications with low power consumption. Each haptic tower 408 can be powered through the micro controller 404, or independently powered. Alternatively, step 2 504 may involve a micro controller 404 that only codes data from a program content data store in the CPU 406, and not require sensor 402 captured user data. The coded signal from the micro controller 404 actuates the haptic tower 408 to perform the process of delivering targeted air flow of variable intensity and temperature.

Still referring to FIG. 5, step 3 506 describes the micro controller 404 instructing the haptic tower 408 to actuate a power output to control variability of air flow rate. In a preferred embodiment, the micro controller 404 instructs the haptic tower 408 to actuate a motor 204 with variable controlled speed output for powering a fan assembly 202. In alternative embodiments, the air flow results in air flow of variable intensity by the micro controller 404 instructing the haptic tower 408 to actuate a valve in creating variable air flow rate. In yet another embodiment, a brake for tight control of the output air flow from the fan assembly 202 may result in the variability of air flow rate. In yet another configuration of the communication protocol, the CPU may send the coordinates of the haptic experience to an on-board micro-controller (MCU) through a dedicated communication line. The combination of predictive algorithms integrated into the MCU and the communication protocol from the CPU, allows the MCU to predictively lower haptic experience latency to generate a unique and specific entertainment experience. The MCU is configured to interpret the positional data and simultaneously coordinate the actuator array to precisely deliver the haptic output. As a result, allowing the MCU to interpret and drive the haptic experience in an autonomous manner offloads the CPU requirements and decreases latency between the visual image and haptic experiences. Alternatively, series control of the haptic experience may also be integrated into the MCU to off-load CPU demands and decrease latency as well.

Step 4 508 describes a preferred embodiment of the method in which the air flow of variable flow rate may be directed into a specific temperature duct 208 with the use of motored shutters 206. The air flow may be directed to specific shutters 206, whereby it is channeled into respective ducts 208, and appropriately treated by a temperature element 210. Servo motors may control dampers or flat shutters 206, and these shutters 206 will open and close controlling the air flow through different temperature ducts 208.

In continuing reference to FIG. 5, step 5 510 describes an exemplary embodiment of the method in which air flow is directed into either a temperature duct 208 or ambient duct 208, depending on the need for temperature treatment based on a data signal. If temperature treatment is required, step 6 512 describes treating the air by a temperature element 210 in a respective duct 208. After redirecting the air into one of the separate temperature ducts 208, each duct 208 has either a hot or cold temperature element 210. For heated air, the air flows through the “hot” duct 208 with an exposed heating element 210. In a preferred embodiment, the air may flow through an exposed Positive Temperature Coefficient (PTC) ceramic heater element, or any thermistor with a high non-linear thermal response, such as barium titanate or lead titanate composites. In other embodiments, the heating element 210 may be a condenser heat sink in a vapor-compression cycle, thermoelectric heating using Peltier plates, Ranque-Hilsch vortex tube, gas-fire burner, quartz heat lamps, or quartz tungsten heating, without departing from the scope of the invention. For the “cold” duct 208, the air flows through a cooling element 210. In a preferred embodiment, the air may flow through a traditional finned air conditioning condenser in a vapor-compression cycle. Alternate embodiments of the cooling element 210 may include an evaporator heat sink in a vapor-compression cycle or thermoelectric cooling using the Peltier effect, chilled water cooler, Ranque-Hilsch vortex tube, evaporative cooling, magnetic refrigeration, without departing from the scope of the invention. In alternate embodiments, the air from the fan assembly 202 is directed into a single temperature duct 208, where the air is exposed to both heating and cooling temperature elements 210 integrated into the single temperature duct 208. Other embodiments may include heating or cooling the air flow into any number of shutters 206, temperature ducts 208, and temperature elements 210.

Step 7 514 describes directing ambient air through a duct 208 without a temperature element 210. In alternate embodiments, the redirected air flow may be all directed into a single duct 208, regardless of the requirement for ambient or temperature treatment. In accordance with this embodiment, the air from the fan assembly 202 may be directed into a single duct 208, where the air may be exposed to either heating or cooling temperature elements 210 integrated into the single duct 208, depending on the temperature requirement. Ambient air may bypass both temperature elements 210 integrated into the single duct 208. Other embodiments may include heating or cooling the air flow into any number of shutters 206, temperature ducts 208, and temperature elements 210, without departing from the scope of the invention.

In yet another reference to FIG. 5, step 8 516 describes the delivery of air flow of variable flow rate and temperature-exposed air or ambient air onto the user. In an exemplary aspect, delivery of temperature-treated or ambient air may be via dispensing nozzles 112 on the front wall 126 of the haptic tower 408. The front wall 126 may have a dispensing nozzle 112 hidden behind a flush wall with the means of opening and closing. The dispensing nozzle 112 may have separate outlets for air, fog, and mist. Additionally, the dispensing nozzle 112 may have the ability to rotate, or change the diameter of the inlet, in order to target the direction of the air flow, as well as alter the intensity of the air flow. The haptic tower 408 may have a front wall 126 void of dispensing nozzles 112, rather, the haptic delivery may be via a vent system, or any other outlet.

In further detail, still referring to step 8 516 of FIG. 5, the haptic tower 408 may have a rotatable base 114, which may pivot the haptic tower 408 in at least one axis of motion. A rotating base 114 allows for the haptic tower 408 to rotate on its base to allow for more targeted delivery of haptic effects. More particularly, a rotating base 114 may allow for the haptic tower 408 to rotate on its base in at least one axis of motion to provide for a panning air flow effect. In other embodiments, the rotatable base 114 may allow for motion along multiple axis of rotation. In one embodiment, pivoting and targeted haptic delivery may be further enhanced by using head tracking or full body tracking system. Other embodiments may include a haptic tower 408 with a dispensing nozzle 112, the pivoting and rotation of which may be also enhanced with the addition of head tracking or full body tracking systems.

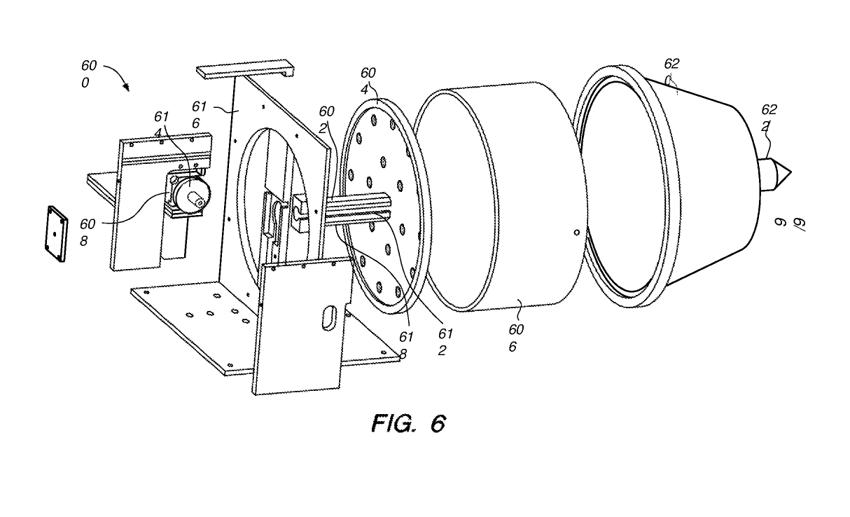

Now, finally, in reference to FIG. 6. FIG. 6 describes a side, exploded perspective of the piston chamber assembly of the air bursting effect system according to an aspect of the invention. In a preferred embodiment, the piston chamber assembly 600 dispenses a high-velocity blast of air to targeted portions of a user based on data from a user in the virtual and real space. The chamber assembly 600 may be integrated as part of the haptic tower 408, housed proximally to any one of or combination of fan assembly 102, shutter 106, air duct 108, and, or temperature element 110. The haptic tower 408 with integrated piston chamber assembly 600 may still be modular enough for resting on the floor or operating as a counter-top device, configured to deliver precise, latent-free air bursting effect in order to maximize a user's immersive experience. Alternatively, the piston chamber assembly 600 may be housed externally to the haptic tower 408. The piston chamber assembly 600 may have a piston 602 with a large-diameter piston head 604 at the distal end for maximal surface area air displacement. The piston 602 and head 604 are dimensioned to be fittingly disposed within a displacement barrel 606 and in slidable communication with the inner wall of the displacement barrel 606. The non-head proximal end of the piston 602 may be coupled to any one of actuators 608, wherein activation of the actuator results in high-velocity movement of the piston 602, and thus, causes displacement of air creating a constant, intense bursting effect.

In continuing reference to FIG. 6, the actuator 608 may be a spring-loaded system coupled to a DC motor 608 driving a drive-train 612. At the proximal end of the drive-train is a sector gear 614. This sector gear 614 engages the rack 616 on the piston 602; pulls the piston 602 into the cocked state by compressing a compression spring 618; and then the sector gear 614 releases the rack 616 attached to the piston 602, releasing the piston 602 and causing air displacement through the displacement barrel 606 and dispensed through the air blast outlet 622. In alternative embodiments, the spring-loaded system may be coupled to any number of motive power sources, whether based on the Lorentz force and the flow of electric current or not. These motive sources may be used to drive the piston 602, and may include the interactive force exerted on a magnet or magnetically susceptible materials (electromagnets, reluctance motors, induction motors, synchronous motors, etc.).

While not shown in FIG. 6, one embodiment of the piston-coupled motive force may be powered through an electromagnetic system. An electromagnet or plurality of electromagnets may be used to create forward displacing force when the stored charge in capacitors is released into the coil of wire. The spring-load system coupled to the piston 602 and the electromagnet would operate similarly to the previously described embodiments: the sector gear 614 at the proximal end of the drive-train engages the rack 616 on the piston 602; pulls the piston 602 into the cocked state by compressing a compression spring 618; and then the sector gear 614 releases the rack 616 attached to the piston 602, releasing the piston 602 and causing air displacement through the displacement barrel 606 and dispensed through the air blast outlet 622. The advantages of using an electromagnet is that there is significantly less noise when compared to a drive-train and motor assembly. The pulling force on the electromagnet is along the axis of the piston 602 direction. Another advantage to an electromagnet system is the precision control of the electromagnetic force using standard microcontroller and other simplistic electronics design. Contrastingly, a DC motor is an array of electromagnets that are activated with timing to rotate the shaft in a direction and afford less precision control in terms of activation and deactivation of actuation. Being able to vary the force of the electromagnet would be able to control the velocity of the piston 602 and as a result, vary the output intensity of the air blast through the displacement barrel 606 and air blast outlet 622.

Other forms of actuation for causing motive force propulsion of the piston may be any one of, or combination of, hydraulic, pneumatic, and, or gas. In these embodiments, the spring-loaded mechanism—featuring the sector gear, rack, etc.—coupled to the actuator may not be needed. Instead, pneumatic fluid, hydraulic fluid, and, or gas is pressurized and enters the displacement barrel to be applied against the slidably disposed piston member upon actuation.

While also not shown in FIG. 6, piston design and piston configuration may vary to maximize air blast effect in the context of the specific immersive experience. One piston-chamber assembly design may include a tapered piston 602 and displacement barrel 606 in order to generate increased air blast. The inner walls of the displacement barrel 606 may be brushed smooth or have spiral grooves or any other design feature in order to maximize air flow dynamics. The preferred embodiment for a piston configuration includes a single piston-chamber assembly, however, other embodiments of the piston-chamber assembly may include a multi-piston configuration. Multi-piston configurations may include an in-line system of multiple pistons 602 fittingly disposed within a large displacement barrel 606. Other embodiments may include an in-line system, wherein each piston 602 is disposed within its own displacement barrel 606, whereby the displaced air at the distal end of each barrel 606 converge upon a single valve operably connected to a dispensing nozzle 620 and air burst outlet 622. Another embodiment of the multi-piston configuration may include a staggered-width alignment, an opposably stacked alignment, or any other possible alignment of a block of pistons 602.

Although not shown in FIG. 6, alternative embodiments to a piston driver may include the use of a linear actuator, which may be a motor attached to a lead screw that transfers rotational motion into linear motion. Linear actuators can reload fast and move fast, therefore deliver actuation with extremely low latency. Other mechanisms for displacing air through the displacement barrel 606 and dispensing nozzle 620—other than a piston or lead screw—may be used, so long as it is slidably disposed within the inner walls of the displacement barrel 606.

In a preferred embodiment, the air blast from the piston-chamber assembly may achieve variable temperature by being housed proximal to the impellor-fan 102, shutter 106, air duct 108, and, or temperature element 110 assembly. By having the air blast outlet 622 adjacent to the impellor fan-assembly coupled dispensing nozzle 112, temperature treated air from the impellor fan assembly may converge with the blasted air from the piston-chamber assembly, creating the effect of a temperature treated air blast specific to the user's immersive experience. Alternative embodiments may include a vale and shutter system redirecting the temperature treated air into the piston-chamber assembly resulting in air blast of variable temperature. In yet another alternative embodiment, a temperature element may be integrated within any one of, or combination of the displacement barrel 606, dispensing duct, dispensing nozzle 620, and, or air blast outlet 622.

Still in reference to FIG. 6, target specificity of the air blast may be achieved by a rotating air blast outlet 622. Another feature to enhance immersion is to control the direction of the haptic tower 408 using motors which allow haptic towers 408 to pivot in place by its rotatable base 114 and mimic the virtual environment the user is in. This can be further enhanced by a rotating air blast outlet 622. Head and body tracking may also be used for the control and aiming of the rotatable dispensing nozzle 112 and rotating blast outlet 622. Additionally, in an alternative embodiment, the fitting of a mechanical iris can change the diameter of an opening of the air blast outlet 622, the mechanical control of which may be a spiral shutter attached to a servo motor or DC motor. These features effectuate targeted delivery of haptic effects, enhancing the immersive VR experience for the user.

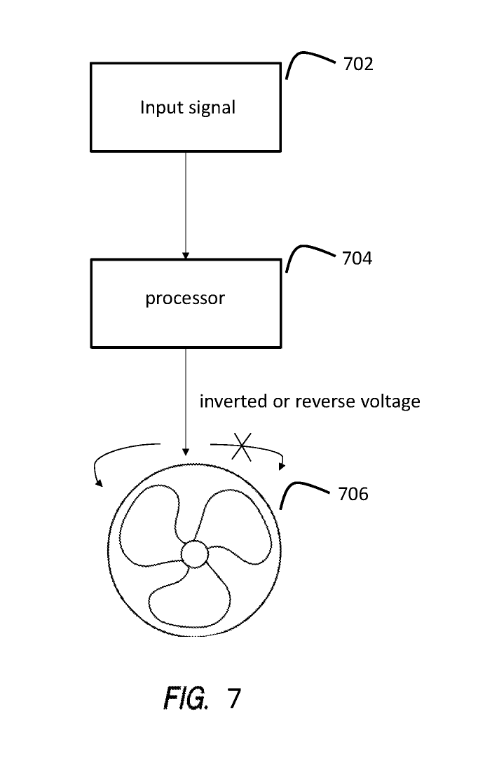

Now in reference to FIG. 7. FIG. 7 illustrates a block diagram of the latency control features enabling the system to dispense latent-free air flow from a counter-top tower based on data from a user from at least one of a virtual and real space. In a preferred embodiment, the system comprises a housing configured in the form of a counter-top tower, wherein the housing is enclosed with a top wall, bottom wall, and side walls adjoining a front wall with a back wall; the counter-top tower is separate from at least one of a CPU and a source of program content, wherein the counter-top tower communicates with at least one of the CPU and the source of program content by at least one of a wired and wireless communication protocol. Furthermore, the system further comprises a fan 706 coupled to a variable motor output 706 disposed within the housing to control an air flow intensity; at least one duct disposed within the housing; at least one temperature element disposed within the housing to control temperature of the air flow to be dispensed; at least one dispensing nozzle in communication with the at least one duct, wherein the at least one dispensing nozzle is disposed on a surface of the housing. The system , furthermore, comprises a processor 704; a memory element coupled to the processor 704; encoded instructions; wherein the system is configured to receive data input 702 from a user; receive data input 702 from a program content; and based on the received data input 702 from at least one of the user and the program content, control an intensity of the motor output 706 to create a variable intensity of air flow; control an intensity of the temperature element to create a variable temperature of the air flow to be dispensed to a head/torso region of the user via the dispensing nozzle on the surface of the housing; and control an intensity of at least one of the motor output 706 and fan 706 by generating at least one of a reverse voltage and inverted voltage for enabling a sudden stop or slow down of at least one of the motor output 706 and fan 706 to achieve latent free air flow corresponding to the users virtual environment.

Low latency motor control for the impeller fan 706 is important because it allows for dynamic and quick responses in haptic effects that mirror the experience one is having. Explosions in games and video occur very quickly (<1 second), and as a result, the fan 706 speed needs to change speeds very quickly. If this latency control or active braking is not used, the haptic experience feels washed out because of the inertia of the impeller; the user experiences wind that is Jaggy or washed out. Latency control or active braking is achieved by inverting the voltage or reversing the voltage on a motor output 706 creating a braking event. As we travel through an experience, we have a set point that the motor chip or processor 704 is constantly trying to follow by accelerating or decelerating the motor output 706 to match the set point. The braking in a fan is the key to a tight experience that can appear to move fluidly within the game.

In some embodiments, the feedback control of the voltage is achieved by applying a small part of the output voltage signal back to the inverting (−) input terminal via a Rf−R2 voltage divider network, again producing negative feedback. This application of voltage is based on the input signal 702 from at least one of a user data, program content, etc. processed. This closed-loop configuration produces a non-inverting amplifier circuit with a very high input impedance, Rin approaching infinity, and a low output impedance. In some embodiments, the reverse or inverted voltage causes an immediate rotation of the motor output 706 in a reverse direction causing a sudden stop or slow down of the impellor fan 706. In other embodiments, the reverse or inverted voltage does not reverse rotation of the motor output when causing a sudden stop or slow down of the impellor fan 706. The feedback voltage control achieving latency control of the motor output 706 and fan 706 may be achieved by any number of industry accepted standards.

In continuing reference to FIG. 7, another embodiment may comprise a processor; a memory element coupled to the processor 704; and encoded instructions. The system may further comprise at least one sensing means configured for detecting at least one of the following data related to a user's orientation and position, environmental conditions in user's real environment, and user's input signal; and based on the receive data input 702 from at least one of the user and program content, control an air flow intensity; direct the air flow through at least one duct; control a temperature element for heating or cooling of the air flow; and control an intensity of at least one of the motor output 706 and fan 706 by generating a reverse or inverted voltage for enabling a sudden stop or slow down of at least one of the motor output 706 and fan 706 for latent free control of the air flow.

Still in reference to FIG. 7, in yet another embodiment, the at least one tower may comprise of at least one air displacement assembly configured to channel displaced air through a duct; a single or plurality of sensors configured to monitor and sense at least one of a user position, movement, environment, and context; a networking or user interface for configurably controlling the at least one tower according to a user-defined haptic output; and encoded instructions that cause a personalized haptic output with latency control achieved by at least one of a reverse or inverted voltage applied to or by a motor output 706 coupled to a fan 706 based on any one of, or combination of, a sensed input 702 and a user-defined input 702.

While not shown in FIG. 7, a method for delivering a latent-free haptic output is disclosed. The method may comprise two steps: (1) controlling an intensity of a motor output to create a variable intensity of air flow; and (2) controlling an intensity of at least one of the motor output and fan by generating a reverse voltage or inverted voltage for enabling a sudden stop or slow down of at least one of the motor output and fan for latent free control of the air flow.

Therefore, the foregoing is considered as illustrative only of the principles of the invention. Further, since numerous modifications and changes will readily be apparent to those skilled in the art, all suitable modifications and equivalents may be considered as falling within the scope of the invention.

We claim:

1. A system for dispensing latent-free air flow from a counter-top tower based on data from a user from at least one of a virtual and real space, said system comprising:
a housing configured in the form of a counter-top tower, wherein said housing is enclosed with a top wall, bottom wall, and side walls adjoining a front wall with a back wall;
said counter-top tower separate from at least one of a CPU and a source of program content, wherein said counter-top tower communicates with at least one of the CPU and the source of program content by at least one of a wired and wireless communication protocol;
a fan coupled to a variable motor output disposed within the housing to control an air flow intensity;
at least one duct disposed within the housing;
at least one temperature element disposed within the housing to control temperature of the air flow to be dispensed;
at least one dispensing nozzle in communication with said at least one duct, wherein the at least one dispensing nozzle is disposed on a surface of the housing;
a processor;
a memory element coupled to the processor;
encoded instructions;
wherein the system is further configured to receive data input from a user;
receive data input from a program content;
based on the received data input from at least one of the user and the program content, control an intensity of the motor output to create a variable intensity of air flow;
control an intensity of the temperature element to create a variable temperature of the air flow to be dispensed to a head/torso region of the user via the dispensing nozzle on the surface of the housing; and
control an intensity of at least one of the motor output and fan by generating a reverse voltage or inverted voltage for enabling a sudden stop or slow down of at least one of the motor output and fan for latent free control of the air flow.

2. The system of claim 1, further comprising an air burst outlet that is disposed at a terminal end of the duct, whereby air flow from said air burst outlet is in communication with a variable temperature treated air flow from a secondary air flow outlet.

3. The system of claim 2, wherein the air flow from said air burst outlet is in communication with the temperature element causing an air burst from said air burst outlet with a variable temperature.

4. The system of claim 2, wherein the air burst outlet further comprises a dispensing nozzle adjustable for at least one of an aperture diameter and nozzle direction.

5. The system of claim 1, wherein the housing comprises at least one actuator for causing pivot of the housing in at least one axis motion.

6. The system of claim 1, wherein said dispensing nozzle further comprises at least one actuator for causing pivot of the dispensing nozzle in at least one axis of motion.

7. The system of claim 1, further comprising a fog and mist dispensing system, wherein the fog and dispensing system further comprises:
at least one fluid supply line in fluid communication with at least one fluid supply and with at least one outlet;
condensing means for air and fluid from the at least one fluid supply; and
dispensing fog or mist via the at least one fluid supply line for output to a user.

8. A computer system comprising:
a processor;
a memory element coupled to the processor;
encoded instructions;
at least one sensing means configured for detecting data related to a user's orientation and position, environmental conditions in user's real environment, and user's input signal;
wherein the computer system is further configured to:
receive data input from a user;
receive data input from a program coupled to an experience;
based on the received input data, control an air flow intensity;
based on the received input data, direct the air flow through at least one duct;
based on the received input data, control a temperature element for heating or cooling the said air flow; and
based on the received input data, control an intensity of at least one of the motor output and fan by generating a reverse or inverted voltage for enabling a sudden stop or slow down of at least one of the motor output and fan for latent free control of the air flow.

9. The system of claim 8, comprising a user interface, wherein the user interface is integrated as a built-in console display, mobile device display, wearable device display, monitors, or access devices.

10. The system of claim 9, wherein the user interface comprises:
a display page for receiving a request for a haptic output selection, said request being from a menu, a haptic suggestion engine, or user-initiated;
a display page for prompting a user to confirm the request; and
a display page for signaling to the user one or more of communications, said communications describing confirmation of request and initialization.

11. The system of claim 9, wherein the user interface authenticates a user by an authentication module detecting a short-range tag coupled to a user device.

12. The system of claim 8, further comprising a remote server configured to:
provide a user-control system, wherein said server authenticates the user by recognizing the user device at a system component; identify the system component by authenticating a uniqute tag on said component;
authenticate the user device at the component; and retrieve data of the user and apply said data against a predefined criteria of use.

13. The system of claim 12, wherein the remote server is further configured to:
provide a contextually-aware haptic output suggestion engine, wherein the contextually-aware haptic output suggestion engine accesses a user haptic output history function and at least one user contextual information to cause the processor to display a suggested haptic output on at least one display interface.

14. The system of claim 8, further comprising a haptic tower, wherein said haptic tower is associated with an Internet of Things, whereby the haptic tower is fully integrated into a user's home automation system, thereby providing additional contextual information for a contextually aware haptic output suggestion engine.

15. The system of claim 8, wherein the at least one sensing means further includes any one of the following:
a body-tracking sensor;
a head-tracking sensor; and
a eye-gaze tracking sensor.

16. The system of claim 14, further comprising a communication protocol, wherein a CPU signals instructions to an on-board haptic tower micro controller, said instructions configuring the micro controller for simultaneous actuation of control output of the haptic tower.

17. A system comprising:
at least one tower comprised of at least one air displacement assembly configured to channel displaced air through a duct;
a single or plurality of sensors configured to monitor and sense at least one of a user position, movement, environment, and context;
a networking or user interface for configurably controlling the at least one tower according to a user-defined haptic output; and
encoded instructions that cause a personalized haptic output with latency control achieved by at least one of a reverse or inverted voltage applied to or by a motor output coupled to a fan based on any one of, or combination of, a sensed input and a user-defined input.

18. A method for dispensing latent-free air flow from a counter-top tower based on data from a user from at least one of a virtual and real space, said method comprising:
controlling an intensity of a motor output to create a variable intensity of air flow; and
controlling an intensity of at least one of the motor output and fan by generating a reverse voltage or inverted voltage for enabling a sudden stop or slow down of at least one of the motor output and fan for latent free control of the air flow.
